(19) United States
(12) Patent Application Publication
(10) Pub. No.: US 2026/0030363 A1
(43) Pub. Date: Jan. 29, 2026

(54) CHATBOT RISK MANAGEMENT

(71) Applicant: Capital One Services, LLC, McLean, VA (US)

(72) Inventors: Satyajit Sajanrao NALAVADE, Mckinney, TX (US); Paul LY, Wylie, TX (US); Vikramaditya REPAKA, Coppell, TX (US); Kamlesh TALREJA, Bellevue, WA (US); Christopher NICOTRA, Holiday, FL (US)

(21) Appl. No.: 18/787,767

(22) Filed: Jul. 29, 2024

(51) Int. Cl. G06F 21/57; G06F 40/35

(52) U.S. Cl. CPC G06F 21/577; G06F 40/35; G06F 2221/034

(57) ABSTRACT

Some implementations described herein relate to a system for chatbot risk management. The system is configured to receive, from a user device that includes a chatbot interface, user input associated with the chatbot interface. The system is configured to determine, based on the user input, intent information. The system is configured to select, based on the intent information, a chatbot service from a generative-artificial-intelligence (gen-AI) chatbot service and a non-gen-AI chatbot service. The system is configured to provide the user input to the selected chatbot service to allow the selected chatbot service to generate a response to the user input.

### BACKGROUND

A chatbot is a software application designed to provide automated responses to user input, and thus simulate a conversation between the user and a live agent. A chatbot can be configured to answer questions, provide information, and/or perform tasks.

### SUMMARY

Some implementations described herein relate to a system for chatbot risk management. The system may include one or more memories and one or more processors communicatively coupled to the one or more memories. The one or more processors may be configured to receive, from a user device that includes a chatbot interface, user input associated with the chatbot interface. The one or more processors may be configured to determine, based on the user input, intent information. The one or more processors may be configured to select, based on the intent information, a chatbot service from a generative-artificial-intelligence (gen-AI) chatbot service and a non-gen-AI chatbot service. The one or more processors may be configured to provide the user input to the selected chatbot service to allow the selected chatbot service to generate a response to the user input.

Some implementations described herein relate to a non-transitory computer-readable medium that stores a set of instructions. The set of instructions, when executed by one or more processors of a system for chatbot risk management, may cause the system for chatbot risk management to determine, based on user input associated with a chatbot interface of a user device, intent information. The set of instructions, when executed by one or more processors of the system for chatbot risk management, may cause the system for chatbot risk management to select, based on the intent information, a chatbot service from a gen-AI chatbot service and one or more non-gen-AI chatbot services. The set of instructions, when executed by one or more processors of the system for chatbot risk management, may cause the system for chatbot risk management to provide the user input to the selected chatbot service to allow the selected chatbot service to generate a response to the user input.

Some implementations described herein relate to a method. The method may include selecting, by a system for chatbot risk management and based on user input associated with a chatbot interface, a chatbot service from a gen-AI chatbot service and a non-gen-AI chatbot service. The method may include providing, by the system, the user input to the selected chatbot service to allow the selected chatbot service to generate a response to the user input.

### BRIEF DESCRIPTION OF THE DRAWINGS

FIGS. 1A-1D are diagrams of an example implementation associated with chatbot risk management, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with chatbot risk management, in accordance with some embodiments of the present disclosure.

FIG. 4 is a flowchart of an example process associated with chatbot risk management, in accordance with some embodiments of the present disclosure.

### DETAILED DESCRIPTION

The following detailed description of example implementations refers to the accompanying drawings. The same reference numbers in different drawings may identify the same or similar elements.

A chatbot uses a chatbot service to generate responses to user input. That is, the user device can include a chatbot interface (e.g., that presents the chatbot to a user of the user device), into which a user enters user input. The user input is then passed, from the user device, to a chatbot service (e.g., that is hosted by a backend system), which then generates a response to the user input. The chatbot service provides the response to the user device and the response is then presented to the user via the chatbot interface of the user device.

The chatbot service can be, for example, a gen-AI chatbot service (e.g., that is configured to dynamically generate responses using advanced language models) or a non-gen-AI chatbot service (e.g., that is configured to generate response using predefined rules). In many cases, a gen-AI chatbot service can provide a natural-seeming response to a user input. However, such a response is not predictable and can lack informational precision, or in some cases, can include incorrect information (e.g., due to a gen-AI “hallucination”). In contrast, a non-gen-AI chatbot service can provide accurate and relevant response to a user input, as long as the user input is associated with a topic that the non-gen-AI chatbot service is designed to handle. Otherwise, the non-gen-AI chatbot service provides a fallback, or a default, response, which can result in a “conversational dead-end,” where the non-gen-AI chatbot service is not able to provide responses related to the topic.

In some scenarios, a particular type of chatbot response may be preferred, and in other scenarios, another type of chatbot response may be preferred. For example, for a chatbot associated with a chatbot interface that is included on a product webpage of a seller, it may be preferred that factually accurate and relevant responses be provided when a first user input requests information about the product (e.g., information related to specification details of the product), and it may be preferred that an analytical response be provided when a second user input requests a comparison between particular features of the product and particular features of another product. When a gen-AI chatbot service is used to generate responses to both user responses, the gen-AI chatbot service can provide a dynamic, contextually relevant response to the second user input, but, in some cases, can provide a factual incomplete or factually incorrect response to the first user input. Moreover, when a non-gen-AI chatbot service is used to generate responses to both user responses, the non-gen-AI chatbot service can provide a factually complete and factually accurate response to the first user input, but, in some cases, cannot provide a contextually relevant response to the second user input (e.g., beyond just a fallback response). Thus, there is a need for selecting a chatbot service to generate a response to user input based on a type of information sought by the user input, also referred to herein as an intent of the user input.

Some implementations described herein include a chatbot risk management system. The chatbot risk management system obtains a user input associated with a chatbot interface of a user device. The chatbot risk management system then determines intent information associated with the user input. The intent information may indicate, for example, a purpose or goal of the user input. The intent infomercial may indicate whether the user input is an information-seeking user input, whether the user input is a recommendation-seeking user input, or whether the user input is an analysis-seeking user input, among other examples. In some implementations, the intent information may indicate one or more intents of the user input.

The chatbot risk management system then selects (e.g., based on the intent information) a chatbot service, from a gen-AI chatbot service and one or more non-gen-AI chatbot service services, that is to be used to generate a response to the user input. In some implementations, to select the chatbot service, the chatbot risk management system identifies (e.g., based on the intent information) at least one intent of the user input. The chatbot risk management system then determines (e.g., based on the at least one intent of the user input) whether the user input is associated with an intent blocklist or an intent allowlist (e.g., of one or more intent allowlists) to thereby determine which chatbot service should be selected. For example, the chatbot risk management system may select, when the user input is associated with the intent blocklist, a non-gen-AI chatbot service that is configured to respond to disallowed user inputs; may select, when the user input is associated with an intent allowlist associated with a particular intent type, a non-gen-AI chatbot service that is configured to respond to user inputs associated with the particular intent type; or may select, when the user input is associated with an intent allowlist associated with a non-particular intent type, the gen-AI chatbot service that is configured to respond to user inputs associated with the non-particular intent type. The chatbot risk management system then provides the user input to the selected chatbot service to allow the selected chatbot service to generate a response to the user input.

Accordingly, the chatbot risk management system selects a non-gen-AI chatbot service to respond to the user input when the non-gen-AI chatbot service is configured to provide a factually complete and/or factually accurate response to the user input, and selects the gen-AI chatbot service to respond to the user input when the user input requires a dynamic, contextually relevant response. Such a chatbot functionality is not otherwise practically available.

Further, in some implementations, the chatbot risk management system only selects the gen-AI chatbot service to respond to the user input when the chatbot risk management system determines that a non-gen-AI chatbot service is not suitable to respond to the user input. This limits a user's interactions with the gen-AI chatbot service, which reduces a likelihood of a poor user experience (e.g., that would otherwise result from responses to user input that are incorrect or irrelevant, such as due to gen-AI hallucinations). Additionally, limiting interactions with gen-AI chatbot service also reduces an amount of computing resources (e.g., processing resources, memory resources, communication resources, and/or power resources, among other examples) that are used to converse with the user (e.g., because, in many cases, more computing resources are consumed when a gen-AI chatbot service is used to respond to a user input than when a non-gen-AI chatbot service is used to respond to the user input).

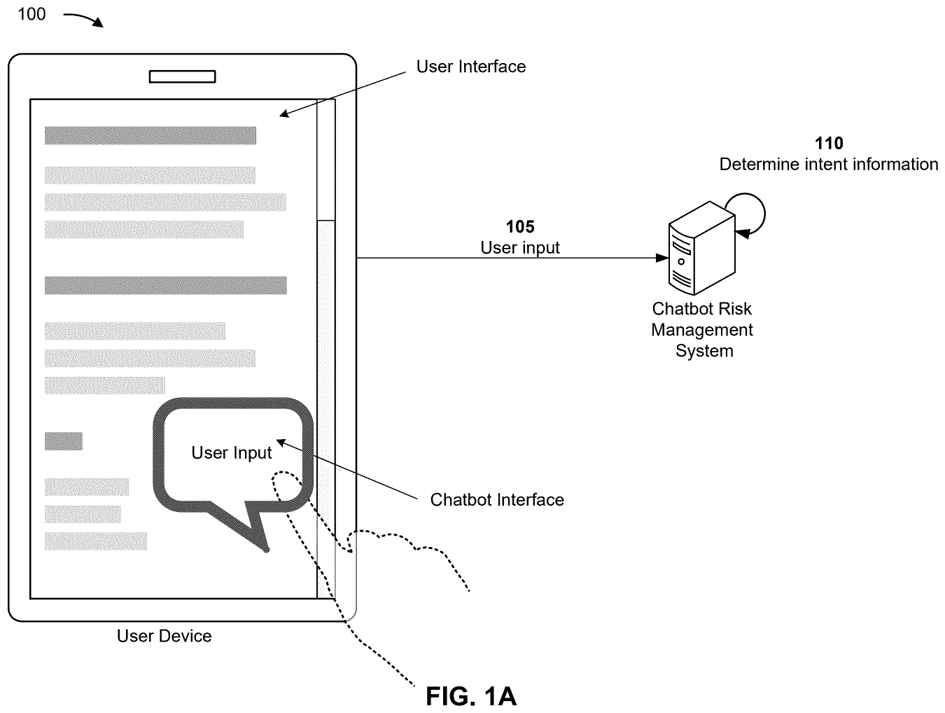

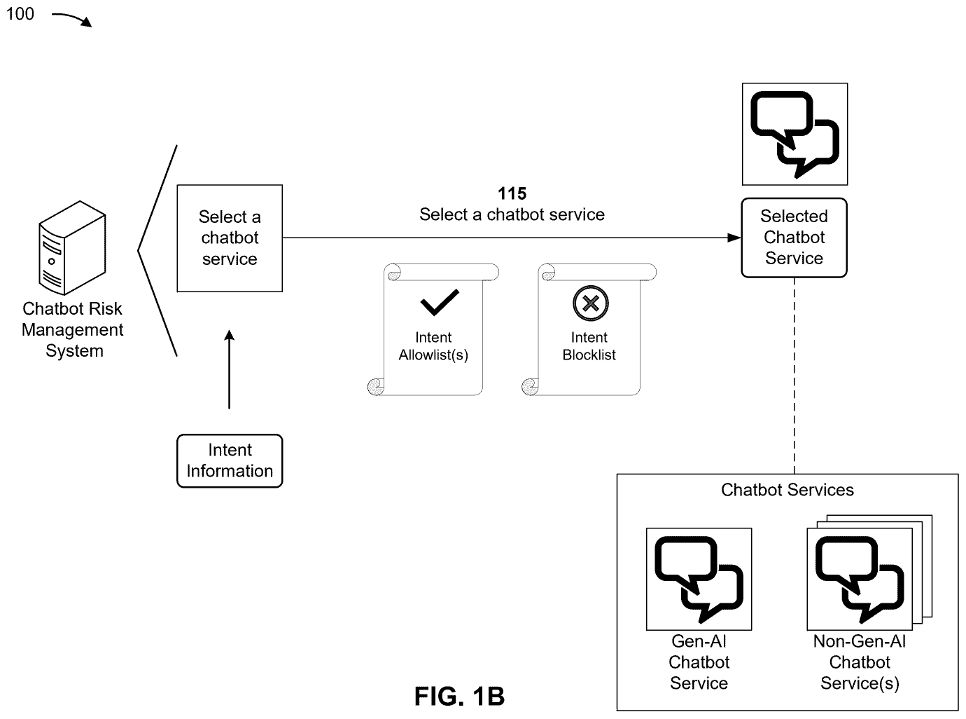

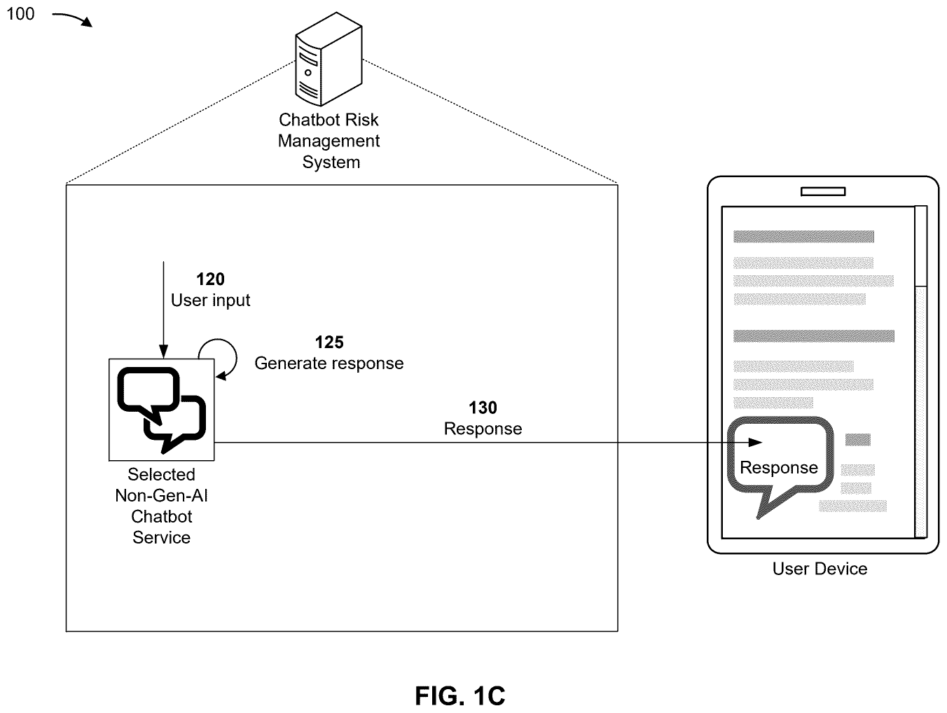

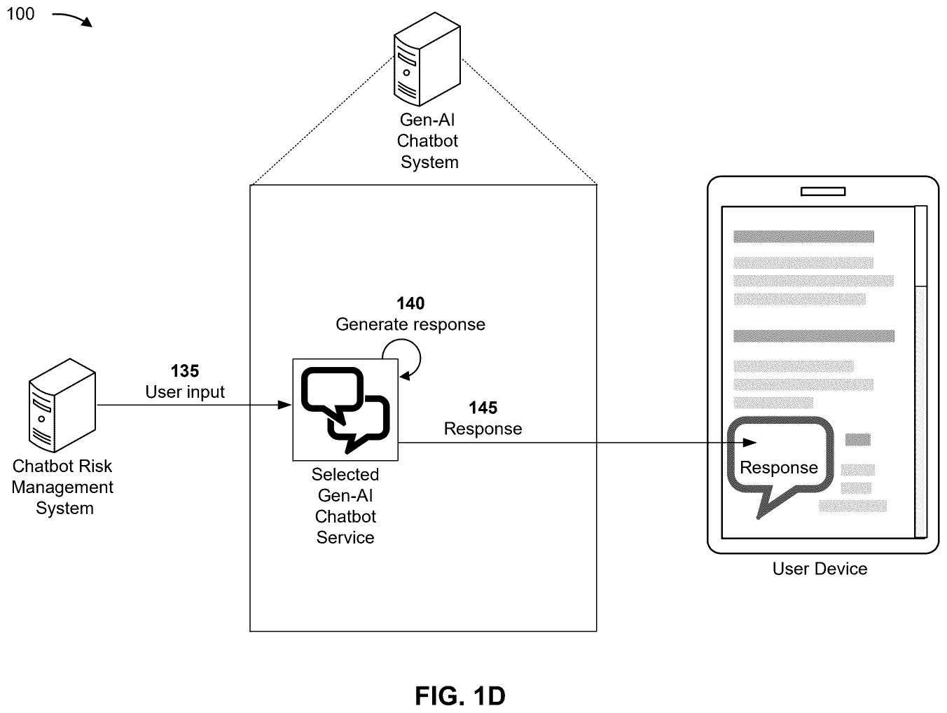

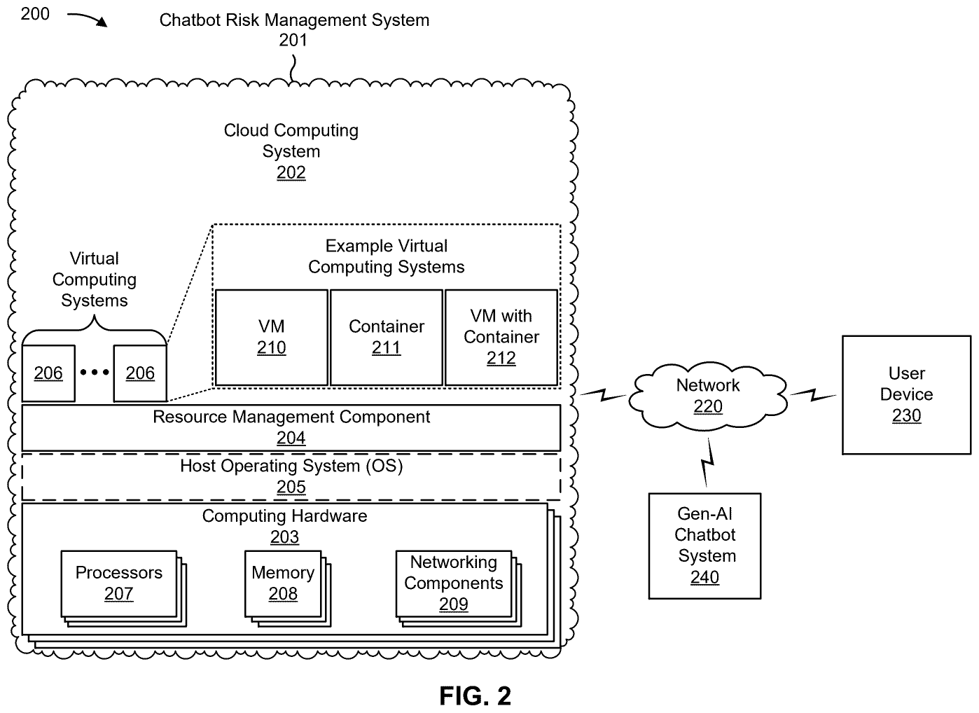

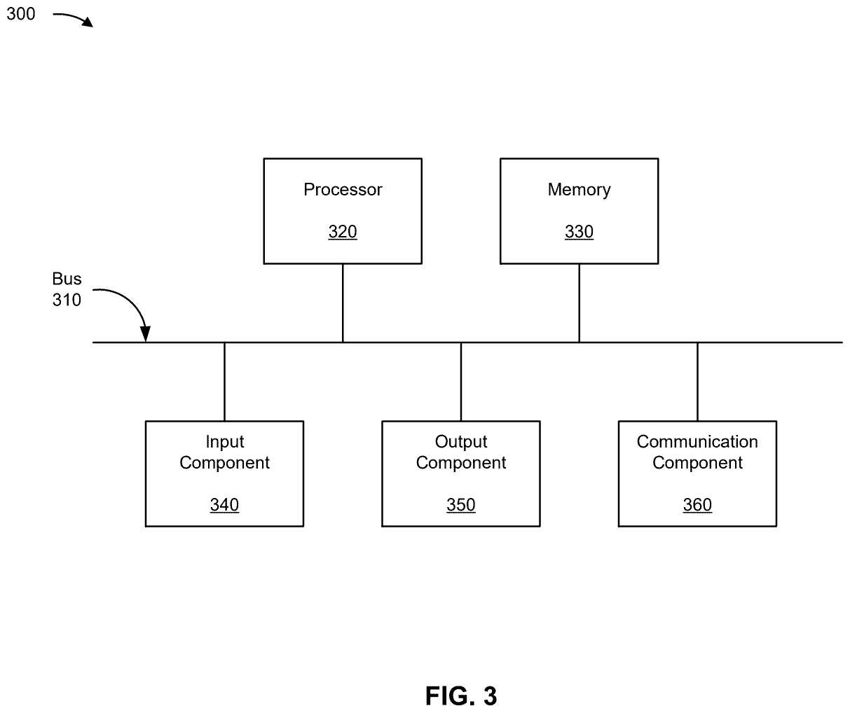

FIGS. 1A-1D are diagrams of an example implementation 100 associated with chatbot risk management. As shown in FIGS. 1A-1D, example implementation 100 includes a chatbot risk management system, a user device, and/or a gen-AI chatbot system. These devices are described in more detail below in connection with FIG. 2 and FIG. 3.

The user device may be associated with a user. The user device may implement a user interface (e.g., a graphical user interface), such as a web browser, which allows the user to input information into the user device. In some implementations, the user device includes a chatbot interface (e.g., that is included in the user interface). For example, when the user interface is a web browser, the user interface may present a web page that includes a chatbot interface of the webpage (e.g., as a popup overlay of the web page, or as a panel or section of the webpage). The chatbot interface may be configured to allow the user to “chat” with the chatbot interface, such that the user may enter an input into the chatbot interface and the chatbot interface provides (e.g., as a response to the input) an output (e.g., an automatically generated output) via the chatbot interface to the user, as further described herein.

As shown in FIG. 1A, the user of the user device may interact with the user interface of the user device to enter a user input. The user input may include, for example, a string (e.g., an alphanumeric string), an image file, a video file, an audio file, or another type of input. In some implementations, the user input may be associated with the chatbot interface (e.g., when the user enters the user input into the chatbot interface of the user interface of the user device).

As shown by reference number 105, the chatbot risk management system may obtain the user input. For example, the user device may send the user input, such as via a connection between the user device and chatbot risk management system, to the chatbot risk management system. Accordingly, the chatbot risk management system may receive the user input (e.g., via the connection between the user device and the chatbot risk management system).

As shown by reference number 110, the chatbot risk management system may determine intent information (e.g., based on the user input). The intent information may indicate, for example, a purpose or goal of the user input. The intent infomercial may indicate whether the user input is an information-seeking user input, whether the user input is a recommendation-seeking user input, or whether the user input is an analysis-seeking user input, among other examples. In some implementations, the intent information may indicate one or more intents of the user input. As a specific example, when the chatbot interface is associated with a product website of a seller, the intent information may indicate that an intent of the user input is to contact the seller (e.g., for information related to how to communicate with the seller to buy a product, related to when a store of the seller is open for business, related to how to navigate to the store, or other information), that an intent of the user input is to check an availability of the product (e.g., at the store or a lot of the seller, at a warehouse or off-site location of the seller), that an intent of the user input is to reserve a time to evaluate the product (e.g., to test drive the product, to assess a fit of the product), and/or that an intent of the user input is to purchase or rent the product, among other examples.

In some implementations, the chatbot risk management system may process the user input to determine the intent information. For example, the chatbot risk management system may process the user input using a natural language processing (NLP) technique (e.g., that includes input preprocessing, feature extraction, categorization, intent recognition, and/or context understanding) to determine the intent information.

As shown in FIG. 1B, and by reference number 115, the chatbot risk management system may select a chatbot service (e.g., based on the intent information). The selected chatbot service may be used to generate a response to the user input, as further described herein. The chatbot risk management system may select the chatbot service from a plurality of chatbot services, which may include a gen-AI chatbot service and one or more non-gen-AI chatbot services. That is, the selected chatbot service may be a particular chatbot service, of the plurality of chatbot services, that is to generate a response to the user input. In some implementations, the gen-AI chatbot service may be hosted by the gen-AI chatbot system, and the one or more non-gen-AI chatbot services may be hosted by the chatbot risk management system, as further described herein.

In some implementations, to select the chatbot service, the chatbot risk management system may identify (e.g., based on the intent information) at least one intent of the user input. The chatbot risk management system then may determine (e.g., based on the at least one intent of the user input) whether the user input is associated with an intent blocklist or an intent allowlist (e.g., of one or more intent allowlists) to thereby determine which chatbot service should be selected.

For example, the chatbot risk management system may determine that the at least one intent of the user input is associated with an entry of the intent blocklist. Accordingly, the chatbot risk management system may determine that the user input is associated with the intent blocklist. Thus, the chatbot risk management system may select (e.g., based on determining that the at least one intent of the user input is associated with the entry of the intent blocklist and/or that the user input is associated with the intent blocklist) a non-gen-AI chatbot service, of the one or more non-gen-AI chatbot services, as the selected chatbot service. The non-gen-AI chatbot service may be associated with responding to disallowed user inputs, or may be otherwise associated with the intent blocklist.

As another example, the chatbot risk management system may determine that the at least one intent of the user input is associated with an entry of an intent allowlist of the one or more intent allowlists. The intent allowlist may be associated with a particular intent type, such as an information-seeking intent type, a recommendation-seeking intent type, or another particular intent type. Accordingly, the chatbot risk management system may determine that the user input is associated with the intent allowlist. Thus, the chatbot risk management system may select (e.g., based on determining that the at least one intent of the user input is associated with the entry of the intent allowlist and/or that the user input is associated with the intent allowlist) a non-gen-AI chatbot service, of the one or more non-gen-AI chatbot services, as the selected chatbot service. The non-gen-AI chatbot service may be associated with responding to user inputs associated with the particular intent type, or may be otherwise associated with the intent allowlist.

In an additional example, the chatbot risk management system may determine that the at least one intent of the user input is associated with an entry of an intent allowlist of the one or more intent allowlists. The intent allowlist may be associated with a non-particular intent type (e.g., a non-specific intent type), such as an analysis-seeking intent type or another non-particular intent type. Accordingly, the chatbot risk management system may determine that the user input is associated with the intent allowlist. Thus, the chatbot risk management system may select (e.g., based on determining that the at least one intent of the user input is associated with the entry of the intent allowlist and/or that the user input is associated with the intent allowlist) the gen-AI chatbot service as the selected chatbot service. The gen-AI chatbot service may be associated with responding to user inputs associated with the non-particular intent type, or may be otherwise associated with the intent allowlist.

In this way, the chatbot risk management system may select, when the user input is associated with the intent blocklist, a non-gen-AI chatbot service that is configured to respond to disallowed user inputs; may select, when the user input is associated with an intent allowlist associated with a particular intent type, a non-gen-AI chatbot service that is configured to respond to user inputs associated with the particular intent type; or may select, when the user input is associated with an intent allowlist associated with a non-particular intent type, the gen-AI chatbot service that is configured to respond to user inputs associated with the non-particular intent type. Accordingly, the chatbot risk management system only selects the gen-AI chatbot service to respond to the user input when the chatbot risk management system determines that a non-gen-AI chatbot service is not suitable to respond to the user input.

In some implementations, the chatbot risk management system may provide the user input to the selected chatbot service (e.g., to allow the selected chatbot service to generate a response to the user input), such as described herein in relation to FIGS. 1C and 1D. In some implementations, prior to providing the user input to the selected chatbot service, the chatbot risk management system may determine that the user input includes sensitive information (e.g., personally identifiable information (PII), protected health information (PHI), or other sensitive information). For example, the chatbot risk management system may process the user input using a sensitive information detection technique (e.g., that includes keyword matching, named entity recognition (NER) analysis, contextual analysis, and/or heuristic rules analysis) to determine that the user input includes sensitive information. Thus, the chatbot risk management system may modify (e.g., based on determining that the user input includes sensitive information), the user input (e.g., by using at least one data anonymization technique or at least one data obfuscation technique), to remove or alter the sensitive information. The chatbot risk management system then may provide the user input (e.g., the modified user input) to the selected chatbot service, as further described herein.

As shown in FIG. 1C, and by reference number 120, when the selected chatbot service is a non-gen-AI chatbot service (e.g., a “selected non-gen-AI chatbot service”), the chatbot risk management system may provide the user input to the selected non-gen-AI chatbot service, which may be hosted by the chatbot risk management system. For example, the selected non-gen-AI chatbot service may be a module, or other functional element, of the chatbot risk management system (e.g., that is executed by the chatbot risk management system). Accordingly, the chatbot risk management system may provide the user input to the selected non-gen-AI chatbot service, such as by passing (e.g., within the chatbot risk management system) the user input to the non-gen-AI chatbot service.

Accordingly, as shown by reference number 125, the selected non-gen-AI chatbot service (e.g., based on being provided the user input) may generate a response to the user input. For example, when the selected non-gen-AI chatbot service is associated with responding to disallowed user inputs, the selected non-gen-AI chatbot service may generate a response indicating that the user input is invalid or that the selected non-gen-AI chatbot service cannot provide information related to the user input. As another example, when the selected non-gen-AI chatbot service is associated with responding to user inputs associated with a particular intent type, the selected non-gen-AI chatbot service may generate a response indicating information associated with the particular intent type and that is responsive to the user input. In some implementations, the non-gen-AI chatbot service may generate the response by using, for example, a rule-based and/or retrieval-based response generation technique, or another type of non-gen-AI response generation technique.

As shown by reference number 130, the chatbot risk management system may provide the response to the user device (e.g., based on providing the user input to the selected non-gen-AI chatbot service). For example, the chatbot risk management system may obtain the response to the user input (e.g., from the selected non-gen-AI chatbot service) and may send the response, such as via the connection between the user device and the chatbot risk management system, to the user device. Accordingly, the user device may receive the response (e.g., via the connection between the user device and the chatbot risk management system).

As shown in FIG. 1D, and by reference number 135, when the selected chatbot service is the gen-AI chatbot service (e.g., the “selected non-gen-AI chatbot service”), the chatbot risk management system may provide the user input to the selected gen-AI chatbot service, which may be hosted by the gen-AI chatbot system. For example, the chatbot risk management system may send the user input, such as via a connection between the chatbot risk management system and the gen-AI chatbot system, to the gen-AI chatbot system. Thus, the gen-AI chatbot system, and therefore the gen-AI chatbot service, may receive the user input (e.g., via the connection between the chatbot risk management system and the gen-AI chatbot system).

Accordingly, as shown by reference number 140, the selected gen-AI chatbot service (e.g., based on being provided the user input) may generate a response to the user input. For example, when the selected gen-AI chatbot service is associated with responding to user inputs associated with a non-particular intent type, the selected gen-AI chatbot service may generate a response indicating information associated with the non-particular intent type and that is responsive to the user input. In some implementations, the gen-AI chatbot service may generate the response by using, for example, a machine learning model response generation technique, or another type of gen-AI response generation technique.

As shown by reference number 145, the chatbot risk management system may provide the response to the user device (e.g., based on providing the user input to the selected non-gen-AI chatbot service). For example, the chatbot risk management system may obtain the response to the user input (e.g., from the selected non-gen-AI chatbot service) and may send the response, such as via the connection between the user device and the chatbot risk management system, to the user device. Accordingly, the user device may receive the response (e.g., via the connection between the user device and the chatbot risk management system).

As shown in FIGS. 1C and 1D, the response that is provided to the user device may be presented in the user interface of the user device. For example, the response may be presented in the chatbot interface of the user interface of the user device. For example, when the user interface is a web browser, the user interface may present a web page that includes a chatbot interface where the response is presented, to the user, as an output of the chatbot interface (e.g., an output that responds to the user input that was entered into the chatbot interface).

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a chatbot risk management system 201, which may include one or more elements of and/or may execute within a cloud computing system 202. The cloud computing system 202 may include one or more elements 203-212, as described in more detail below. As further shown in FIG. 2, environment 200 may include a network 220, a user device 230, and/or a gen-AI chatbot system 240. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the chatbot risk management system 201 may include one or more elements 203-212 of the cloud computing system 202, may execute within the cloud computing system 202, and/or may be hosted within the cloud computing system 202, in some implementations, the chatbot risk management system 201 may not be cloud-based (e.g., may be implemented outside of a cloud computing system) or may be partially cloud-based. For example, the chatbot risk management system 201 may include one or more devices that are not part of the cloud computing system 202, such as device 300 of FIG. 3, which may include a standalone server or another type of computing device. The chatbot risk management system 201 may host one or more non-gen-AI chatbot services, as described elsewhere herein. The chatbot risk management system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user device 230 may include one or more devices capable of receiving, generating, storing, processing, and/or providing information associated with a chatbot interface, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The Gen-AI chatbot system 240 may include one or more devices capable of receiving, generating, storing, processing, providing, and/or routing information associated with a gen-AI chatbot service, as described elsewhere herein. The Gen-AI chatbot system 240 may include a communication device and/or a computing device. For example, the Gen-AI chatbot system 240 may include a server, such as an application server, a client server, a web server, a database server, a host server, a proxy server, a virtual server (e.g., executing on computing hardware), or a server in a cloud computing system. In some implementations, the Gen-AI chatbot system 240 may include computing hardware used in a cloud computing environment. The gen-AI chatbot system 240 may host a gen-AI chatbot service, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with chatbot risk management. The device 300 may correspond to chatbot risk management system 201, computing hardware 203, user device 230, and/or gen-AI chatbot system 240. In some implementations, chatbot risk management system 201, computing hardware 203, user device 230, and/or gen-AI chatbot system 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

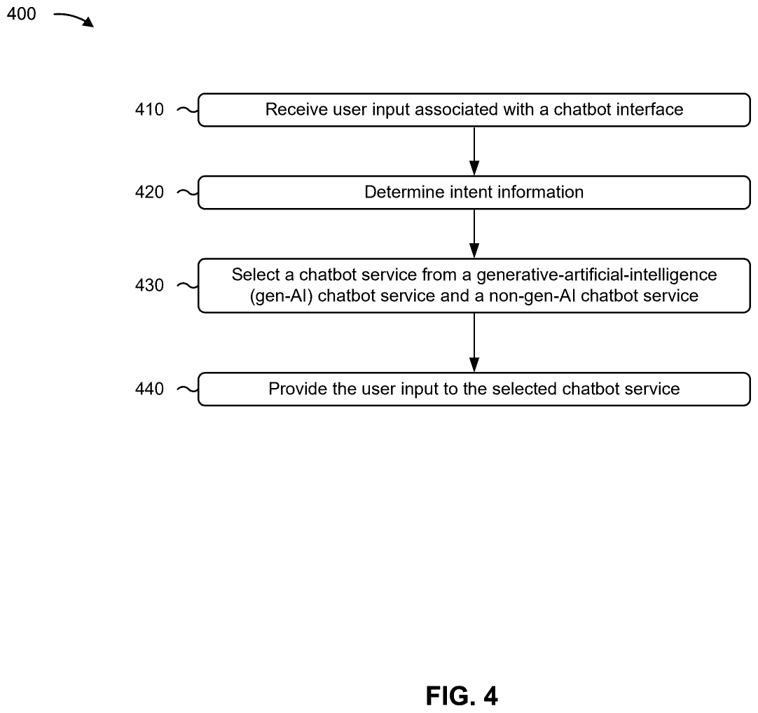

FIG. 4 is a flowchart of an example process 400 associated with chatbot risk management. In some implementations, one or more process blocks of FIG. 4 may be performed by the chatbot risk management system 201. In some implementations, one or more process blocks of FIG. 4 may be performed by another device or a group of devices separate from or including the chatbot risk management system 201, such as the computing hardware 203, the user device 230, and/or the gen-AI chatbot system 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving user input associated with a chatbot interface (block 410). For example, the chatbot risk management system 201 (e.g., using processor 320, memory 330, input component 340, and/or communication component 360) may receive user input associated with a chatbot interface, as described above in connection with reference number 105 of FIG. 1A. As an example, the chatbot risk management system 201 may receive the user input from a user device that includes the chatbot interface.

As further shown in FIG. 4, process 400 may include determining intent information (block 420). For example, the chatbot risk management system 201 (e.g., using processor 320 and/or memory 330) may determine intent information, as described above in connection with reference number 110 of FIG. 1A. As an example, the chatbot risk management system 201 may process the user input using an NLP technique to determine the intent information.

As further shown in FIG. 4, process 400 may include selecting a chatbot service from a gen-AI chatbot service and a non-gen-AI chatbot service (block 430). For example, the chatbot risk management system 201 (e.g., using processor 320 and/or memory 330) may select a chatbot service from a gen-AI chatbot service and a non-gen-AI chatbot service, as described above in connection with reference number 115 of FIG. 1B. As an example, the chatbot risk management system 201 may determine whether the user input is associated with an intent blocklist or an intent allowlist to thereby determine which chatbot service should be selected.

As further shown in FIG. 4, process 400 may include providing the user input to the selected chatbot service (block 440). For example, the chatbot risk management system 201 (e.g., using processor 320 and/or memory 330) may provide the user input to the selected chatbot service, as described above in connection with reference number 120 of FIG. 1C and reference number 135 of FIG. 1D. As an example, the chatbot risk management system 201 may provide the user input to the selected chatbot service to allow the selected chatbot service to generate a response to the user input.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for chatbot risk management, the system comprising:
one or more memories; and
one or more processors, communicatively coupled to the one or more memories, configured to:
receive, from a user device that includes a chatbot interface, user input associated with the chatbot interface;
determine, based on the user input, intent information;
select, based on the intent information, a chatbot service from a generative-artificial-intelligence (gen-AI) chatbot service and a non-gen-AI chatbot service; and
provide the user input to the selected chatbot service to allow the selected chatbot service to generate a response to the user input.

2. The system of claim 1, wherein the one or more processors, to select the chatbot service, are configured to:
identify, based on the intent information, at least one intent of the user input;
determine that the at least one intent is associated with an entry of an intent blocklist; and
select, based on determining that the at least one intent is associated with the entry of the intent blocklist, the non-gen-AI chatbot service, which is associated with responding to disallowed user inputs, as the selected chatbot service.

3. The system of claim 1, wherein the one or more processors, to select the chatbot service, are configured to:
identify, based on the intent information, at least one intent of the user input;
determine that the at least one intent is associated with an entry of an intent allowlist associated with a particular intent type; and
select, based on determining that the at least one intent is associated with the entry of the intent allowlist, the non-gen-AI chatbot service, which is associated with responding to user inputs associated with the particular intent type, as the selected chatbot service.

4. The system of claim 1, wherein the one or more processors, to select the chatbot service, are configured to:
identify, based on the intent information, at least one intent of the user input;
determine that the at least one intent is associated with an entry of an intent allowlist associated with a non-particular intent type; and
select, based on determining that the at least one intent is associated with the entry of the intent allowlist, the gen-AI chatbot service, which is associated with responding to inputs associated with the non-particular intent type, as the selected chatbot service.

5. The system of claim 1, wherein the one or more processors, to provide the user input to the selected chatbot service, are configured to:
determine that the user input includes sensitive information;
modify, based on determining that the user input includes sensitive information, and by using at least one data anonymization technique or at least one data obfuscation technique, the user input; and
provide the modified user input to the selected chatbot service.

6. The system of claim 1, wherein the non-gen-AI chatbot service is hosted by the system.

7. The system of claim 6, wherein the selected chatbot service is the non-gen-AI chatbot service, wherein the one or more processors are further configured to:
obtain, based on providing the user input to the selected chatbot service, the response to the user input; and
send, to the user device, the response.

8. The system of claim 1, wherein the gen-AI chatbot service is hosted by another system.

9. The system of claim 8, wherein the selected chatbot service is the gen-AI chatbot service, wherein the one or more processors are further configured to:
receive, from the other system and based on providing the user input to the selected chatbot service, the response to the user input; and
send, to the user device, the response.

10. A non-transitory computer-readable medium storing a set of instructions, the set of instructions comprising:
one or more instructions that, when executed by one or more processors of a system for chatbot risk management, cause the system to:
determine, based on user input associated with a chatbot interface of a user device, intent information;
select, based on the intent information, a chatbot service from a generative-artificial-intelligence (gen-AI) chatbot service and one or more non-gen-AI chatbot services; and
provide the user input to the selected chatbot service to allow the selected chatbot service to generate a response to the user input.

11. The non-transitory computer-readable medium of claim 10, wherein the one or more instructions, that cause the system to select the chatbot service, cause the system to:
determine, based on the intent information, that the user input is associated with an intent blocklist; and
select, based on determining that the user input is associated with the intent blocklist, a non-gen-AI chatbot service, of the one or more non-gen-AI chatbot services, that is associated with responding to disallowed user inputs as the selected chatbot service.

12. The non-transitory computer-readable medium of claim 10, wherein the one or more instructions, that cause the system to select the chatbot service, cause the system to:
determine, based on the intent information, that the user input is associated with an intent allowlist associated with a particular intent type; and
select, based on determining that the user input is associated with the intent allowlist, a non-gen-AI chatbot service, of the one or more non-gen-AI chatbot services, that is associated with responding to user inputs associated with the particular intent type as the selected chatbot service.

13. The non-transitory computer-readable medium of claim 10, wherein the one or more instructions, that cause the system to select the chatbot service, cause the system to:
determine, based on the intent information, that the user input is associated with an intent allowlist associated with a non-particular intent type; and
select, based on determining that the user input is associated with the intent allowlist, the gen-AI chatbot service as the selected chatbot service.

14. The non-transitory computer-readable medium of claim 10, wherein the one or more instructions, that cause the system to provide the user input to the selected chatbot service, cause the system to:
determine that the user input includes sensitive information;
modify, based on determining that the user input includes sensitive information, the user input; and
provide the modified user input to the selected chatbot service.

15. The non-transitory computer-readable medium of claim 10, wherein the selected chatbot service is hosted by the system, and wherein the one or more processors are further configured to:
obtain, based on providing the user input to the selected chatbot service, the response to the user input; and
send, to the user device, the response.

16. The non-transitory computer-readable medium of claim 10, wherein the gen-AI chatbot service is hosted by another system, and wherein the one or more processors are further configured to:
receive, from the other system and based on providing the user input to the selected chatbot service, the response to the user input; and
send, to the user device, the response.

17. A method, comprising:
selecting, by a system for chatbot risk management and based on user input associated with a chatbot interface, a chatbot service from a generative-artificial-intelligence (gen-AI) chatbot service and a non-gen-AI chatbot service; and
providing, by the system, the user input to the selected chatbot service to allow the selected chatbot service to generate a response to the user input.

18. The method of claim 17, wherein selecting the chatbot service comprises:
determining that the user input is associated with an intent blocklist; and
selecting, based on determining that the user input is associated with the intent blocklist, the non-gen-AI chatbot service.

19. The method of claim 17, wherein selecting the chatbot service comprises:
determining that the user input is associated with an intent allowlist associated with a particular intent type; and
selecting, based on determining that the user input is associated with the intent allowlist, the non-gen-AI chatbot service.

20. The method of claim 17, wherein selecting the chatbot service comprises:
determining that the user input is associated with an intent allowlist associated with a non-particular intent type; and
selecting, based on determining that the user input is associated with the intent allowlist, the gen-AI chatbot service.
